(19) United States
(12) Patent Application Publication
(10) Pub. No.: US 2008/0075008 A1
(43) Pub. Date: Mar. 27, 2008

(54) Transmission apparatus and path establishing method

(75) Inventor: Shinya Kano, Kawasaki (JP)

Correspondence Address: BINGHAM MCCUTCHEN LLP, 2020 K Street, N.W., Intellectual Property Department, WASHINGTON, DC, 20006, US

(73) Assignee: FUJITSU LIMITED

(21) Appl. No.: 11/704,297

(22) Filed: Feb. 9, 2007

(30) Foreign Application Priority Data
Sep. 27, 2006 (JP) 2006-263122

(51) Int. Cl. H04J 3/14; H04L 12/26

(52) U.S. Cl. 370/238; 370/401

(57) ABSTRACT

A transmission apparatus for establishing a path between a start point node and an end point node is disclosed. The transmission apparatus is used as a boundary node between a first area and a second area in a network which is divided into at least the first area and the second area, wherein the start point node resides in the first area and the end point node resides in the second area, the transmission apparatus includes: a calculation unit configured to calculate information related to a route between the start point node and the end point node using topology information of the first area and topology information of the second area when receiving a path request message from the first area based on a signaling protocol for path establishment; and a sending unit configured to send a message including the calculated information related to the route to the start point node.

### BACKGROUND OF THE INVENTION

1. Field of the Invention

The present invention relates to a technique for establishing a data transmission path connecting between designated nodes in a network in which a plurality of nodes are connected by links.

2. Description of the Related Art

There is a technique called MPLS (Multi-Protocol Label Switch) for transferring IP packets based on a label. In the MPLS, a path (LSP: Label Switched Path) is established by setting label tables on a route.

In the MPLS, generally, a start point node obtains a route from the start point node to an end point node and sends a path request message over the route based on a signaling protocol such as RSVP-TE so that a path is established.

An example of path establishment is described with reference to FIG. 1. FIG. 1 shows a network including nodes A-F that are connected as shown in FIG. 1. In the network, when establishing a path of a required bandwidth from the node A to the node F, the node A which is the start point node calculates a route, that satisfies the required bandwidth, from the node A to the node F, first. In the example of FIG. 1, it is assumed that a route of node A→node C→node E→node F is calculated.

The node A generates a path request message (Path) for the node F, and sends the message to the node C that is a next hop. When the node C receives the path request message, the node C removes own node information from the message and sends the message to a next node E, and the node E performs a similar process, so that the path request message is sent to the node F that is the end point node. Then, the node F returns a reserve message (Resv) that is a response message. The reserve message is transferred over the route where the path request message was transferred in a reverse direction so that the reserve message is returned to the start point node. According to such a signaling protocol, label tables are set and the bandwidth is kept so that a path is established.

For sending the path request message, other than the method for designating every intervening node like node A→node C→node E→node F, there is a method in which an intervening node is not designated like node A→node C→node F (which is called loose designation). In this case, the node C which receives the path request message calculates an optimum route and transfers the path request message to an adjacent node.

By the way, GMPLS (Generalized MPLS) has been proposed in which the concept of the label of MPLS that is applied to packet layer for transferring IP packets is generalized to be applied to TDM layer, wavelength path layer and the like. In the GMPLS, wavelength is assigned as the label, for example, to realize switching for each wavelength.

In the IP/MPLS network, control packets that are used in the routing protocol and the signaling protocol can be transmitted over physical medium the same as that for data packets. On the other hand, in the GMPLS network, since there is an interface that cannot identify and process packets, the control packets are transferred via an interface other than an interface for data transmission logically. Therefore, in the GMPLS network, data plane and control plane are logically separated.

But, in the following descriptions, cases are described where control packets and data packets are transmitted over the same physical medium. In addition, in the following, MPLS and GMPLS are collectively called as MPLS/GMPLS. In addition, it is assumed that messages of the routing protocol and the signaling protocol are transferred on an IP network (that corresponds to the control plane) and the network (IP network) may be called as “control network”. The label switch network (that corresponds to the data plane) that is a path network that is a subject network for establishment is called as “transmission network”. In addition, a network including nodes and links is simply called as “network”. For example, a link that connects between nodes is an SDH/SONET path when data is transmitted by SDH/SONET.

Route calculation in MPLS/GMPLS is performed using topology information of the network obtained by each node using the routing protocol such as OSPF-TE (OSPF Traffic Engineering). OSPF-TE is extended, from OSPF that is for IP networks, for MPLS/GMPLS. OSPF-TE is different from OSPF in that it includes available bandwidth of a link in addition to a metric (cost information) as link information that is exchanged among nodes.

When the size of the network becomes large, there are problems in that the capacity of a topology database of each node is increased and that control traffic for distributing link information increases. For solving the problems, there is a method for logically dividing the network to a plurality of areas so that each node exchanges link information in each area. FIG. 2 shows an example in which a network is divided into an area 1 and an area 2.

As shown in FIG. 2, a network of the area 1 includes a node A, a node B, a node C, a node D and a node E, and a network of the area 2 includes a node H, a node F, a node G, a node D and a node E. Each node is connected to another node via a link as shown in FIG. 2. The symbol such as “(10, 1)” on a link represents “(available bandwidth, cost)” for the link. By the way, “available bandwidth” is simply shown as “bandwidth”. In addition, “cost” is a data transmission delay of the link, for example. The larger the cost is, the larger the data transmission delay is.

When the network is divided into areas in this way, each node in the area 1 has topology information only in the area 1 for the transmission network, and each node in the area 2 has topology information only in the area 2 for the transmission network. Each of the nodes D and E that exists on a boundary between the area 1 and the area 2 is called as a boundary node, and each boundary node has topology information for both of the area 1 and the area 2.

In OSPF in the IP network (control network), when the network is divided into areas, a node in an area can receive advertisement of summary information on links of another area. But, in OSPF-TE, there is no function for advertising summary information of an area to another area.

In the network shown in FIG. 2, when establishing a path of a transmission network from the node A to the node H, since the node A does not have topology information of the area 2, the node A cannot automatically calculate a route to the node H. Therefore, there is a problem in that manual procedures are necessary for establishing the path from the node A to the node H so that the path from the node A to the node H cannot be efficiently established. By the way, Japanese Laid-Open Patent Application No. 2006-14032 discloses a conventional technology relating to route calculation.

### SUMMARY OF THE INVENTION

An object of the present invention is to provide a technique for efficiently establishing a path striding over areas in a network that is divided to a plurality of areas.

The object can be achieved by a transmission apparatus for establishing a path between a start point node and an end point node, wherein the transmission apparatus is used as a boundary node between a first area and a second area in a network which is divided into at least the first area and the second area, and the start point node resides in the first area and the end point node resides in the second area, the transmission apparatus including:

a calculation unit configured to calculate information related to a route between the start point node and the end point node using topology information of the first area and topology information of the second area when receiving a path request message from the first area based on a signaling protocol for path establishment; and

a sending unit configured to send a message including the calculated information on the route to the start point node.

The present invention can be also configured as a transmission apparatus used as a start point node on a path between the start point node and an end point node in a network which is divided into at least a first area and a second area, wherein the start point node resides in the first area and the end point node resides in the second area, the transmission apparatus including:

a determination unit configured to determine a boundary node, between the two areas, on a route having a minimum cost between the start point node and the end point node using a routing protocol that can advertise topology summary information between areas;

a sending unit configured to send a path request message including designation of the boundary node to an adjacent node based on a signaling protocol for path establishment;

a receiving unit configured to receive a message, from the adjacent node, that includes information related to a route of the path calculated by the boundary node and that is sent by the boundary node; and

a path establishment processing unit configured to perform processes for establishing the path using the information related to the route included in the message.

According to the present invention, since the transmission apparatus that is a boundary node calculates the information related to the route between the start point node and the end point node using topology information of the first area and topology information of the second area so as to send the information related to the route to the start point node, the start point node can perform path establishment process using the information related to the route. Therefore, according to the present invention, a path striding over areas can be established efficiently in a network that is divided to a plurality of areas.

### BRIEF DESCRIPTION OF THE DRAWINGS

Other objects, features and advantages of the present invention will become more apparent from the following detailed description when read in conjunction with the accompanying drawings, in which:

FIG. 1 is a figure for explaining an example of path establishment;

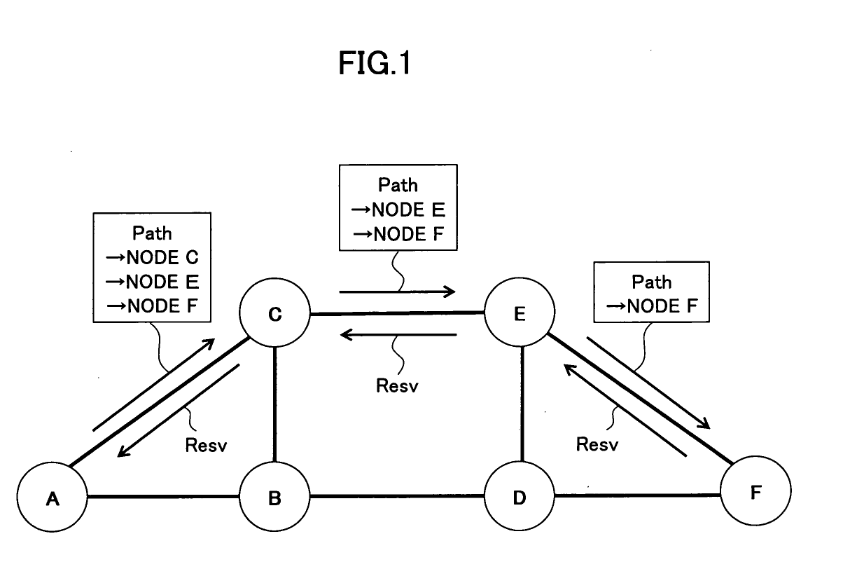

FIG. 2 shows an example in which a network is divided into an area 1 and an area 2;

FIG. 3 is a flowchart for explaining a basic technology;

FIG. 4 is a figure for explaining a method for determining a passing boundary node;

FIG. 5 shows route calculation in the area 1;

FIG. 6 shows transmission of a path request message in the area 1;

FIG. 7 shows route calculation in the area 2;

FIG. 8 is a figure (1) for explaining operation of crank back;

FIG. 9 is a figure (2) for explaining operation of crank back;

FIG. 10 is a figure (3) for explaining operation of crank back;

FIG. 11 is a figure (4) for explaining operation of crank back;

FIG. 12 is a figure (5) for explaining operation of crank back;

FIG. 13 is a figure (6) for explaining operation of crank back;

FIG. 14 is a figure (7) for explaining operation of crank back;

FIG. 15 is a figure (1) for explaining a problem in operation of crank back described in FIGS. 8-14;

FIG. 16 is a figure (2) for explaining a problem in operation of crank back described in FIGS. 8-14;

FIG. 17 is a figure (3) for explaining a problem in operation of crank back described in FIGS. 8-14;

FIG. 18 is a figure (4) for explaining a problem in operation of crank back described in FIGS. 8-14;

FIG. 19 is a figure (1) for explaining a scheme for solving the problem in operation of crank back described in FIGS. 8-14;

FIG. 20 shows a flowchart of the scheme for solving the problem in operation of crank back described in FIGS. 8-14;

FIG. 21 is a figure (2) for explaining a scheme for solving the problem in operation of crank back described in FIGS. 8-14;

FIG. 22 is a figure (3) for explaining a scheme for solving the problem in operation of crank back described in FIGS. 8-14;

FIG. 23 is a figure (4) for explaining a scheme for solving the problem in operation of crank back described in FIGS. 8-14;

FIG. 24 is a figure (5) for explaining a scheme for solving the problem in operation of crank back described in FIGS. 8-14;

FIG. 25 is a figure (6) for explaining a scheme for solving the problem in operation of crank back described in FIGS. 8-14;

FIG. 26 is a figure for explaining a modified example;

FIG. 27 shows a functional configuration example of a transmission apparatus 100 in an embodiment of the present invention;

FIG. 28 is a flowchart showing an operation example of the transmission apparatus 100 in an embodiment of the present invention;

FIG. 29 is a flowchart showing an operation example of the transmission apparatus 100 in an embodiment of the present invention.

### DETAILED DESCRIPTION OF THE PREFERRED EMBODIMENTS

In the following, embodiments of the present invention are described with reference to figures.

In the embodiments, it is assumed that links (SDH/SONET paths, for example) for transferring data of the control network are the same as links for transferring data of the transmission network.

(Basic Operation)

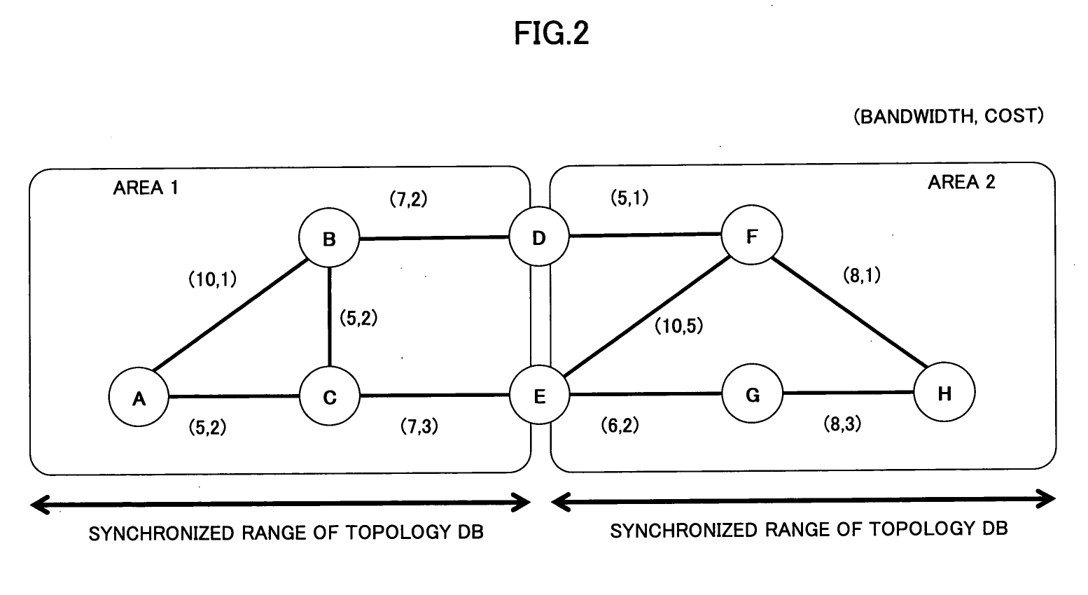

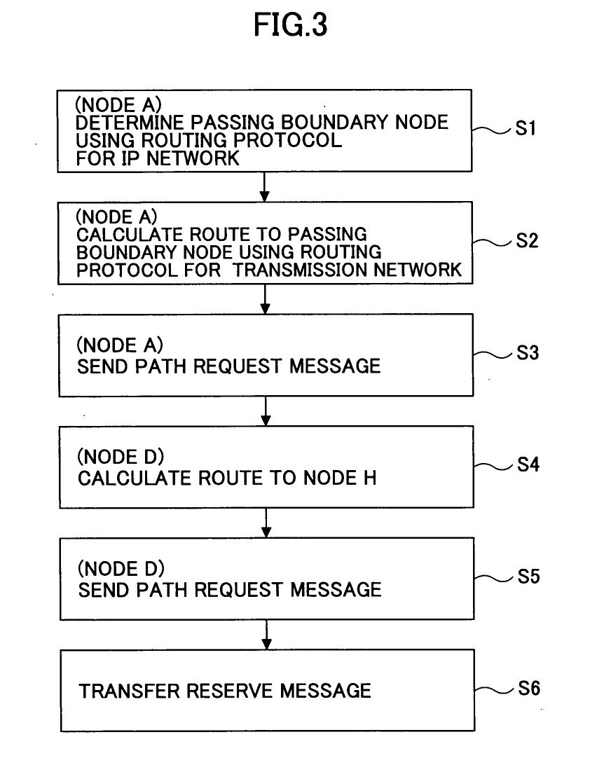

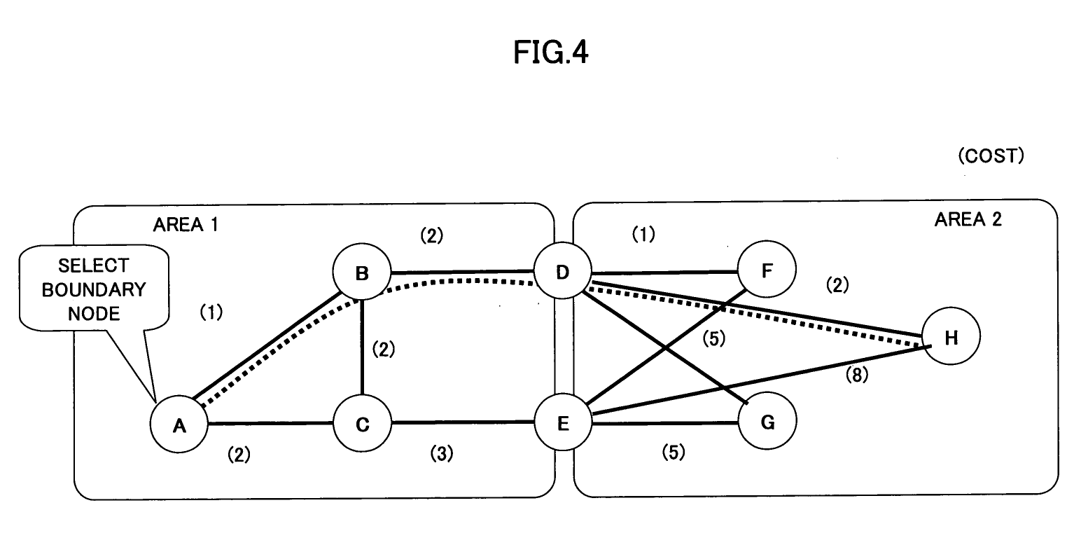

First, a technique on which the present embodiments are based is described with reference to the flowchart shown in FIG. 3. In the following description in each step, FIGS. 4-14 are referred to as necessary. In the following, in the network configuration shown in FIG. 2, a case is described for establishing a path of a transmission network from the node A to the node H in which the required bandwidth is 5.

As described before, since the node A does not have topology information of the area 2 for establishing a path of the transmission network, the node A cannot calculate a route of the path from the node A to the node H that is the end point node. Thus, in this embodiment, following processes are performed.

First, the node A determines an boundary node through which an optimum path passes in step 1 in FIG. 3. This boundary node is called as a passing boundary node.

In the case of FIG. 2, link summary information of the area 2 is advertised to each node in the area 1 from each boundary node. The summary information includes each node in the area 2 that is reachable from the boundary node and includes information of minimum cost to the node.

Therefore, the node A has topology information of all nodes in the area 1 where the node A resides and summary information of the area 2. In the case of FIG. 2, FIG. 4 shows the topology information of the IP network held by the node A. As shown in FIG. 4, the node A has topology information of all nodes in the area 1, information of nodes in the area 2 that are reachable from the boundary node and information of minimum cost from the boundary node to each reachable node.

The node A determines a boundary node on a route having the minimum cost to the node H using the information. In the example shown in FIG. 4, since a route of node A→node B→node D→node H is the route having the minimum cost, the node A determines the node D as the passing boundary node through which the subject path to be established passes.

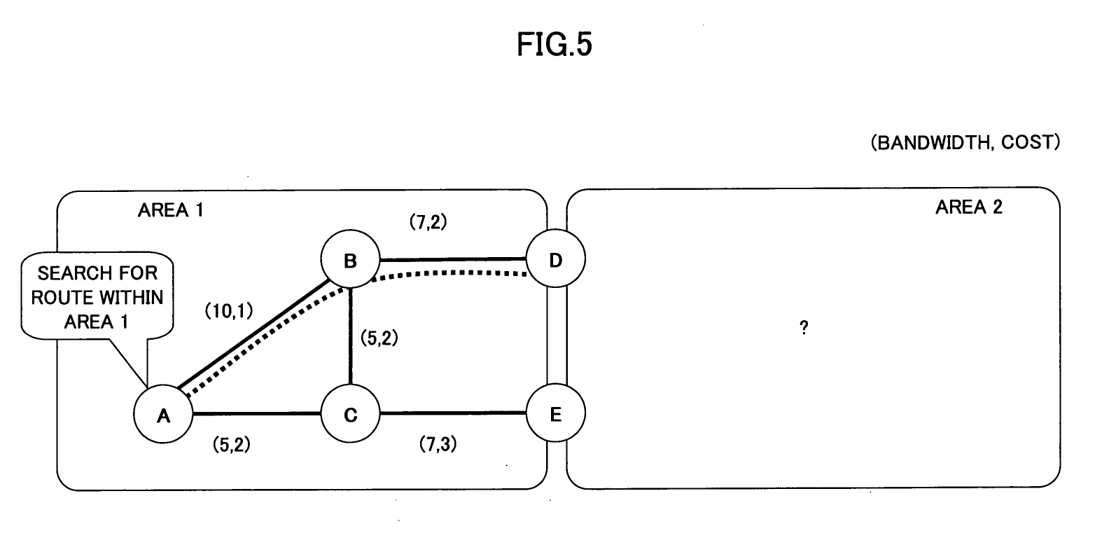

Next, the node A calculates a route to the passing boundary node D that satisfies the required bandwidth (=5) for the path to be established, using the routing protocol (OSPF-TE) of the transmission network in step 2 in FIG. 3. In the area 1, each node has topology information on all nodes in the area 1 by using the routing protocol of the transmission network. Thus, the node A calculates a route to the passing boundary node D-using the topology information. As shown in FIG. 5, in this example, the node A calculates a route of node A→node B→node D.

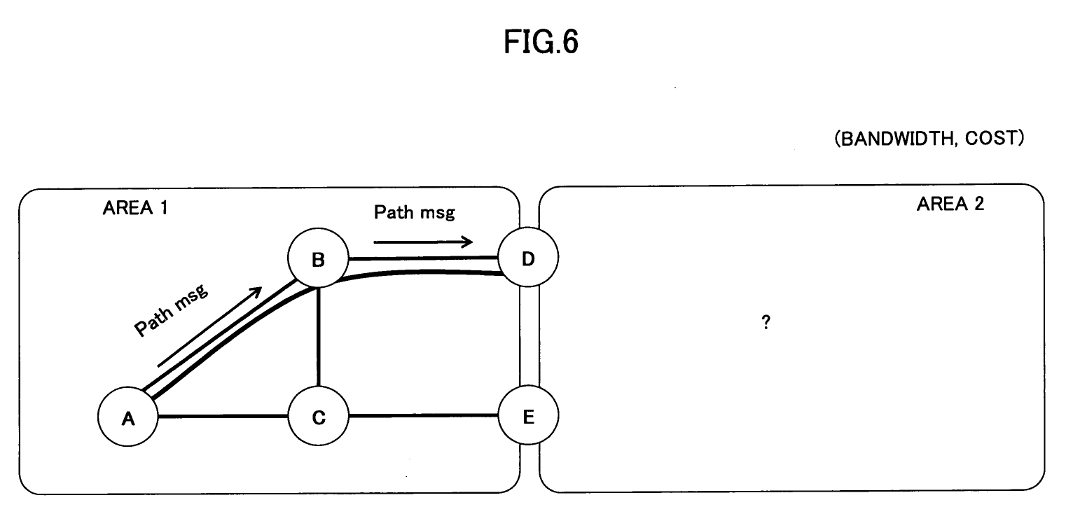

Next, as shown in FIG. 6, the node A sends a path request message for establishing a path using signaling protocol for the transmission network in step 3 in FIG. 3. That is, the node A sends, to the node B, a path request message designating a route of node A→node B→node D→node H. By the way, loose designation is used for the node H.

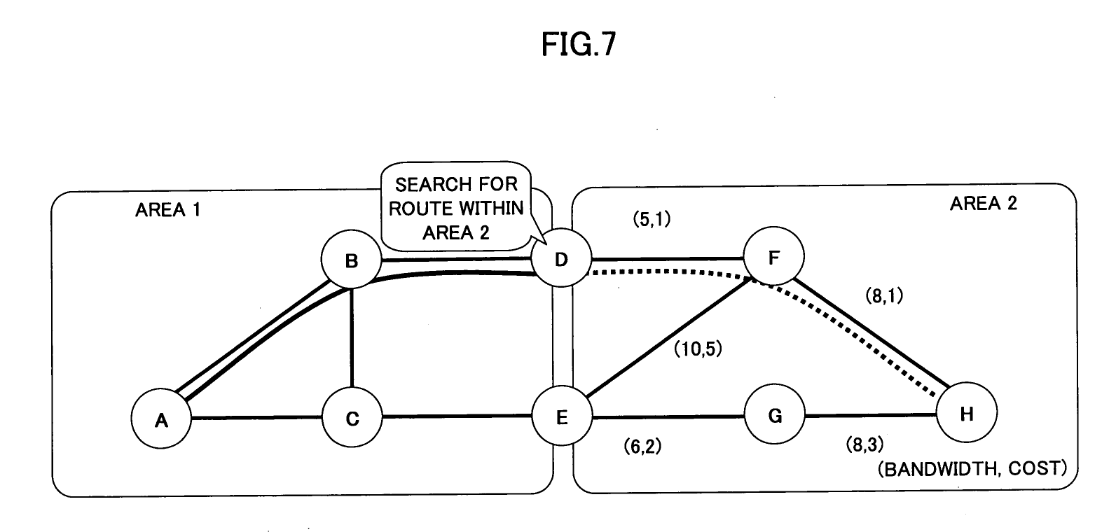

The node D that is the passing boundary node receives the path request message. Since the node D has detailed topology information for the transmission network in the area 2, the node D calculates a route to the node H satisfying required bandwidth=5 using the topology information in step 4 in FIG. 3. As shown in FIG. 7, in this example, a route of node D→node F→node H is calculated. Then, the node D transfers the path request message based on the signaling protocol in step 5 in FIG. 3. After that, based on the signaling protocol, a reserve message is transferred to the node A along the route on which the path request message was transferred in a reverse direction so that a transmission path from the node A to the node H is established in step 6 in FIG. 3.

As described before, in step 4 in FIG. 3, the node D that receives the path request message performs route calculation using the topology information of the area 2 collected by the routing protocol for the transmission network. However, since the node D is determined using the routing protocol for the IP network by the node A, bandwidth for each link in the area 2 is not considered for determining the node D. Therefore, there may be a case in which, when a route from the node D to the node H is calculated in step 4 in FIG. 3, any route that satisfies the required bandwidth cannot be calculated.

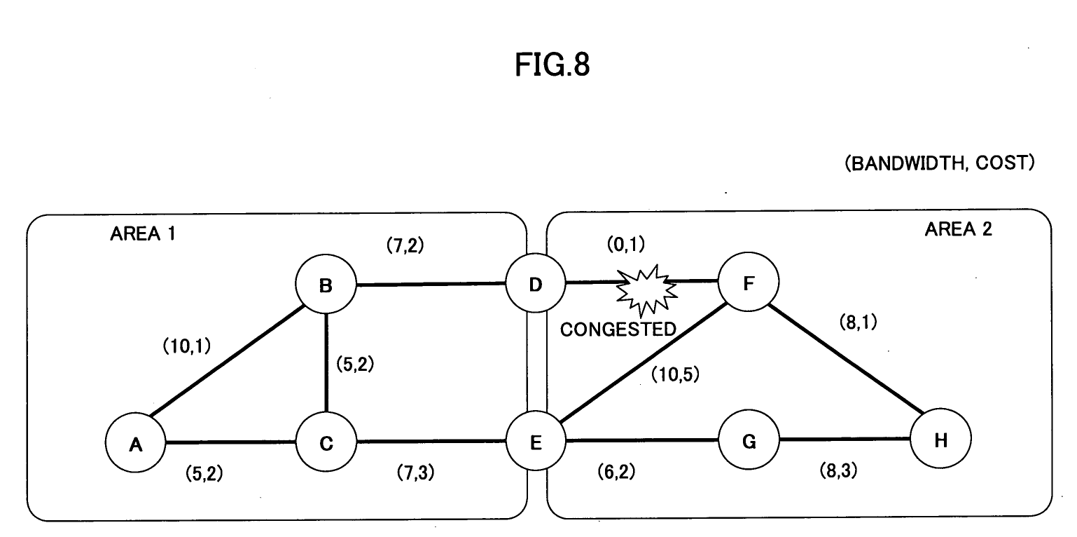

That is, as shown in FIG. 8 for example, when a link from the node D to the node F is congested so that the available bandwidth is 0, there is no route satisfying the required bandwidth=5 from the node D to the node H. Thus, the node D cannot calculate a route to the node H. That is, the route calculation is failed.

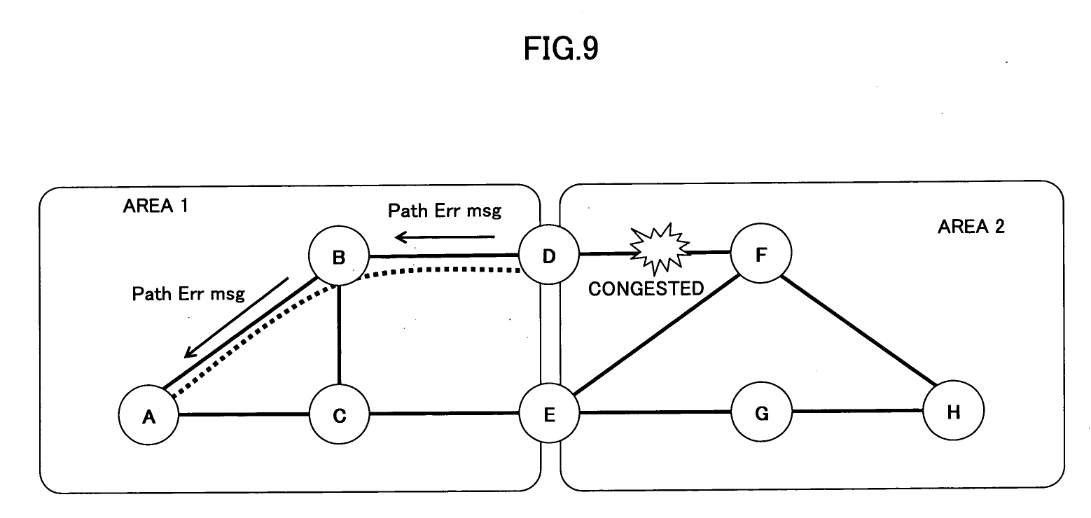

In this case, the node D returns a path error message (Path Err) of the signaling protocol including information indicating that the node D fails in the route calculation to the node A as shown in FIG. 9.

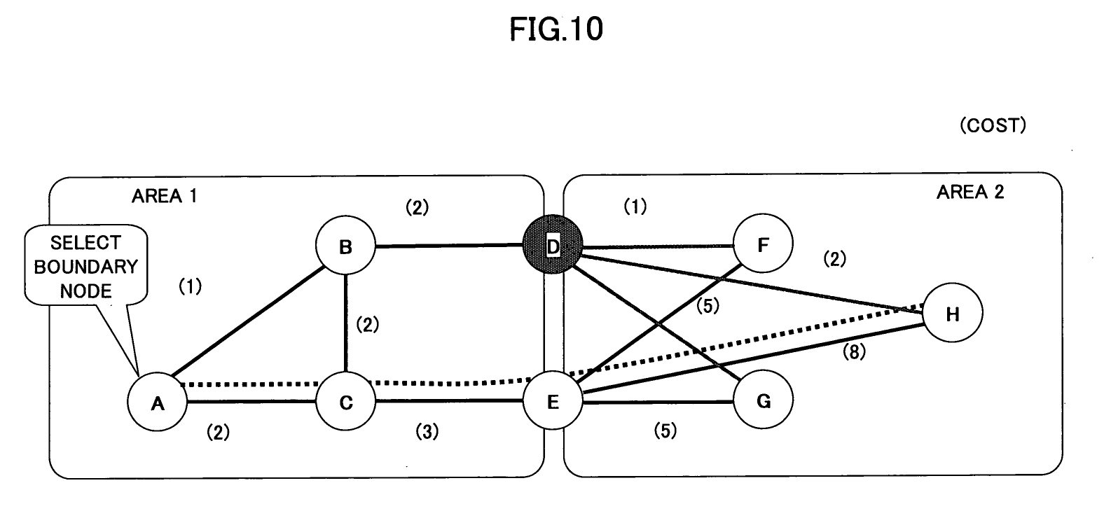

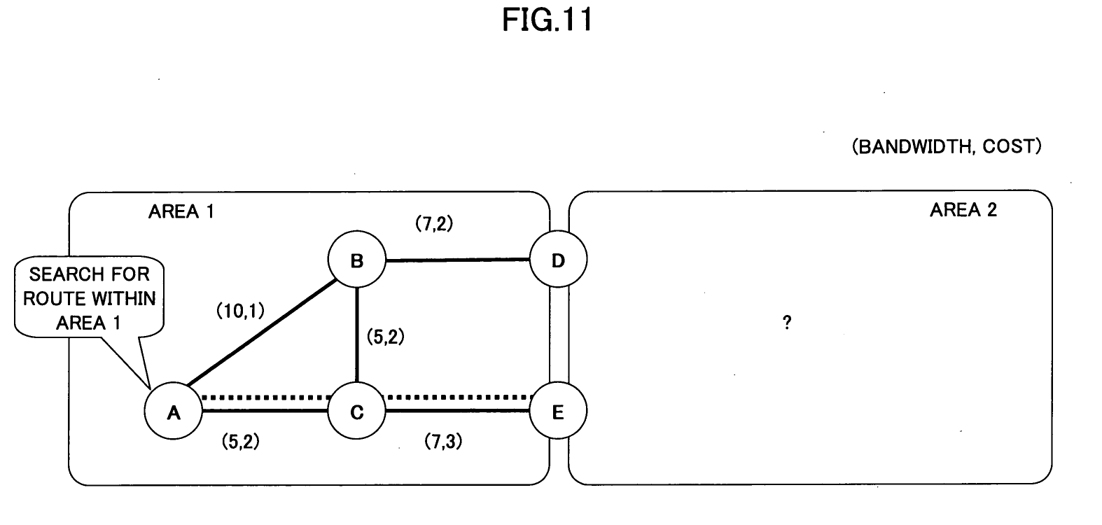

The node A that receives the path error message determines another passing boundary node using the routing protocol of the IP network by excluding the node D in the same way as step 1 of FIG. 3. In the example shown in FIG. 8, the node E is the only candidate boundary node. As shown in FIG. 10, since the node H is reachable from the node E, the node A determines the node E as a passing boundary node. Then, the node A calculates a route in the area 1 satisfying required bandwidth=5 from the node A to the node E using the routing protocol for the transmission network. In this example, as shown in FIG. 11, a route of node A→node C→node E is calculated.

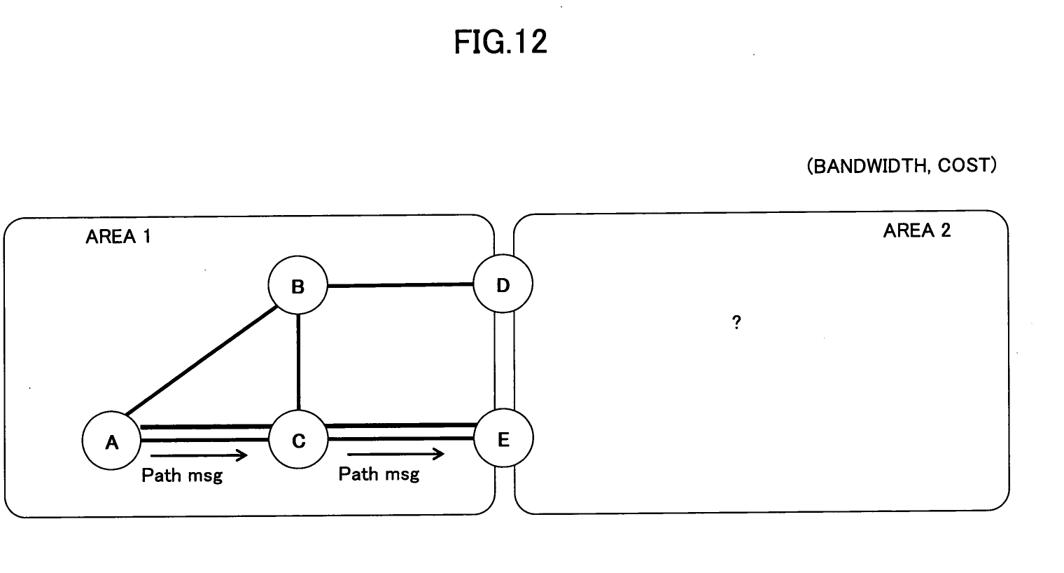

Then, in the same way as step 3 of FIG. 3, the node A sends a path request message designating the node H as a destination to the node C based in the signaling protocol of the transmission network. Then, the path request message is transferred to the node E as shown in FIG. 12. By the way, the technique for reporting a node where error occurs to a previous node so that a route is recalculated by excluding the node where the error occurs is called crank back.

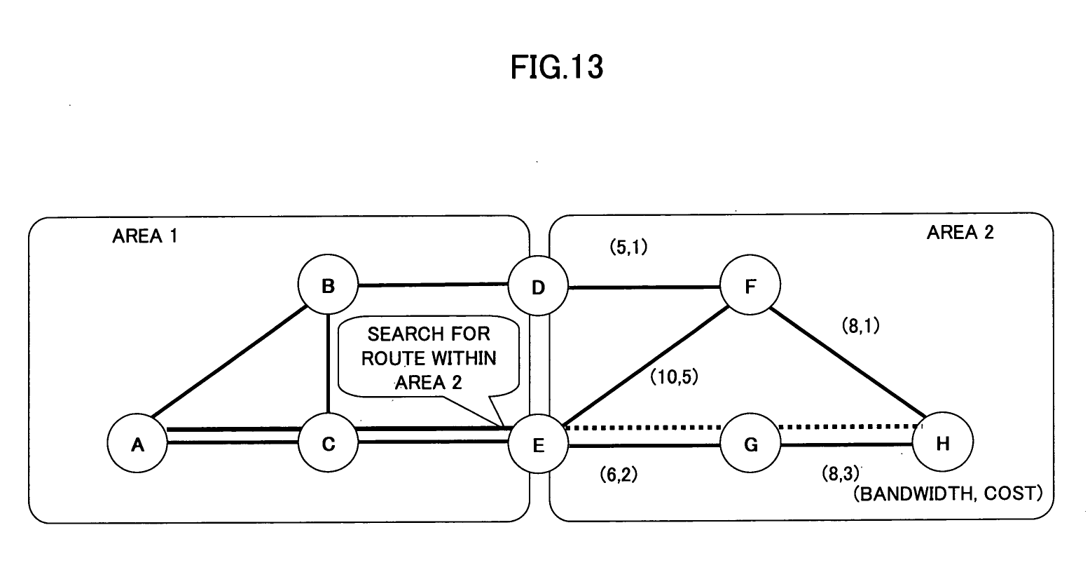

The node E that receives the path request message calculates a route in the area 2 satisfying the required bandwidth=5 to the node H using the routing protocol for the transmission network in the same way as step 4 of FIG. 3. In the example shown in FIG. 8, there are two candidate routes that are node E→node G→node H and node E→node F→node H, and the route of node E→node G→node H having smaller cost is determined as a route for the path to be established as shown in FIG. 13.

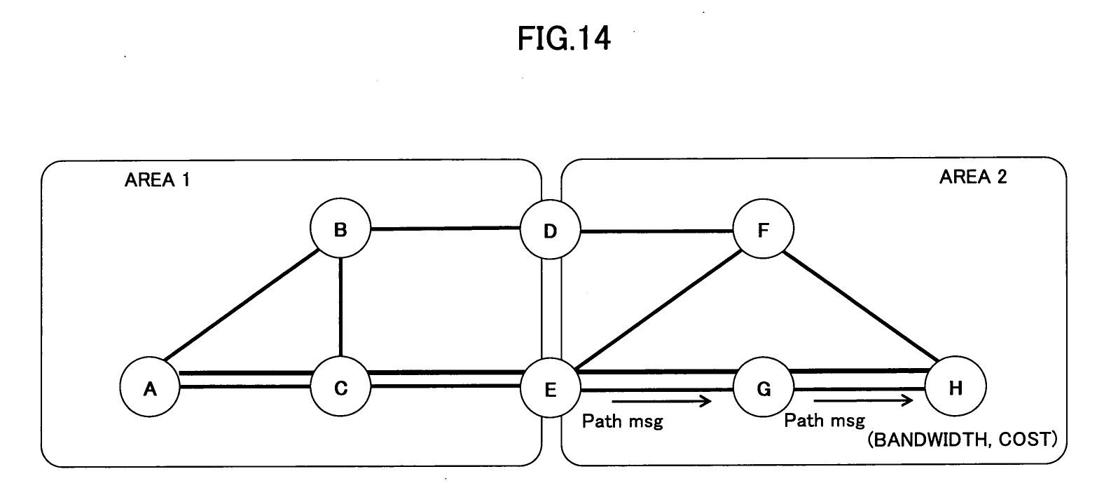

The node E sends the path request message in which the calculated route is designated to the node G based on the signaling protocol of the transmission network. The node G transfers the path request message to the node H as shown in FIG. 14. Then, the node H sends a reserve message to the node G, so that the reserve message is transferred to the node A along the route on which the path request message was transferred in a reverse direction. Accordingly, the path is established as a whole.

(Problems of the Above Mentioned Operation)

The above-mentioned operations solve the problem in which establishment of a path striding over plural areas cannot be automatically performed since the routing protocol of the transmission network cannot collect topology information striding over areas. However, there are following problems in the above-mentioned techniques.

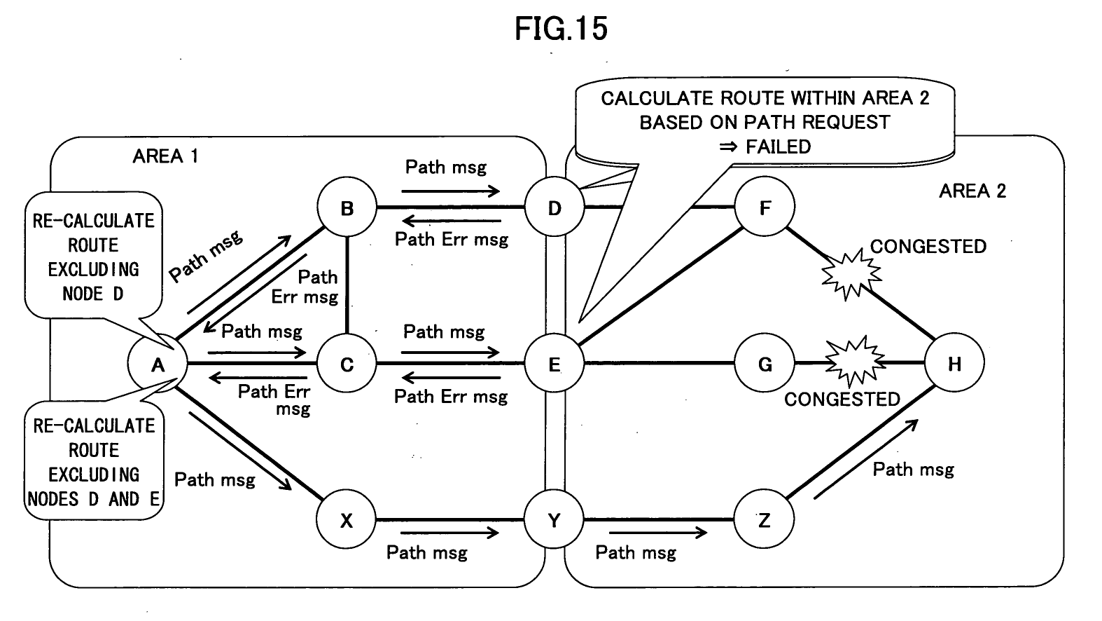

First, as shown in FIG. 15, when the number of the boundary nodes are large, there is a possibility that crack back occurs many times. In the network configuration shown in FIG. 15, assuming that crank back occurs since there is no route satisfying the required bandwidth from the node D to the node H when the node D is initially determined as the passing boundary node using the routing protocol of the IP network. Then, the node A that receives a path error message from the node D determines the node E as a passing boundary node by performing route calculation using the routing protocol of the IP network by excluding the node D. Then, the node A sends a path request message designating a route including the node E, so that the node E that receives the path request message performs route calculation in the area 2 using the routing protocol of the transmission network. But, it is assumed that calculation of a route satisfying the required bandwidth is failed again. Then, crank back occurs again and an error message is returned to the node A. After that, path establishment is succeeded only by selecting the node Y as a passing boundary node.

Accordingly, when the number of the boundary nodes is large, there is a possibility that crank back occurs a plurality of times so that resources of the network and nodes are uselessly used.

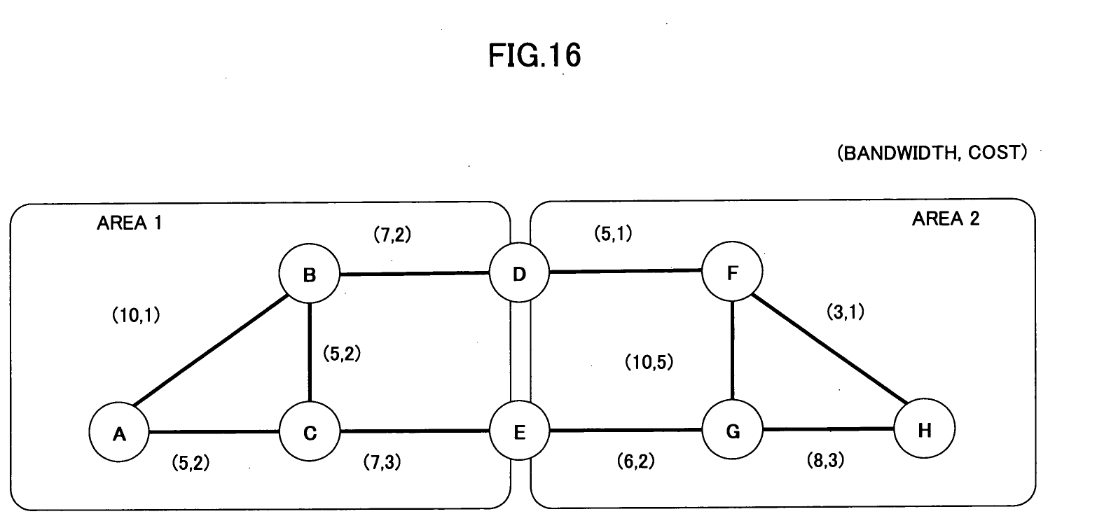

In addition, in the above-mentioned operation, there is a problem in that, even when there is a more suitable route other than a route passing through a boundary node that is selected first, the route may not be selected. This problem is described with reference to FIGS. 16-18.

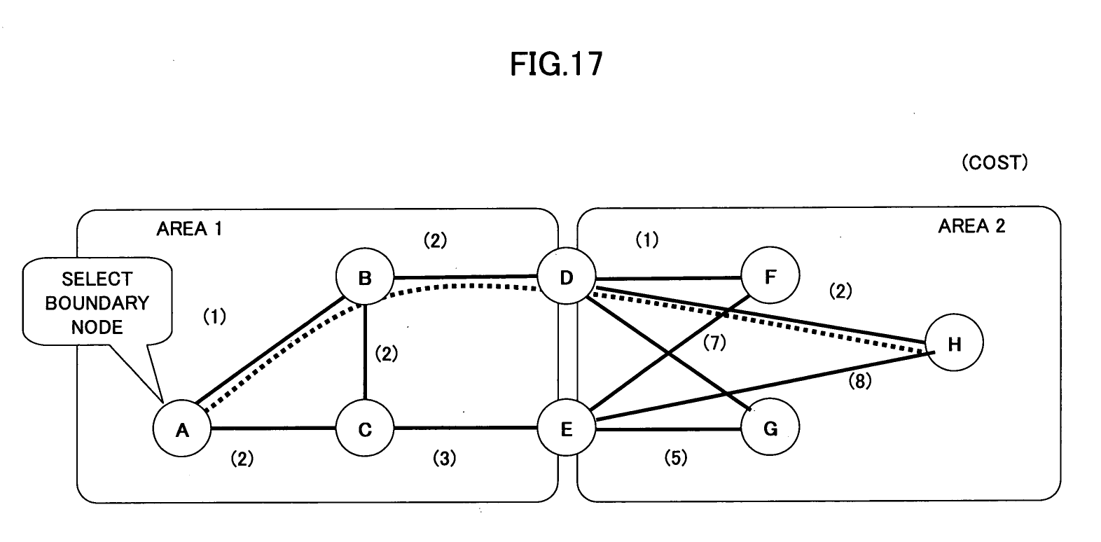

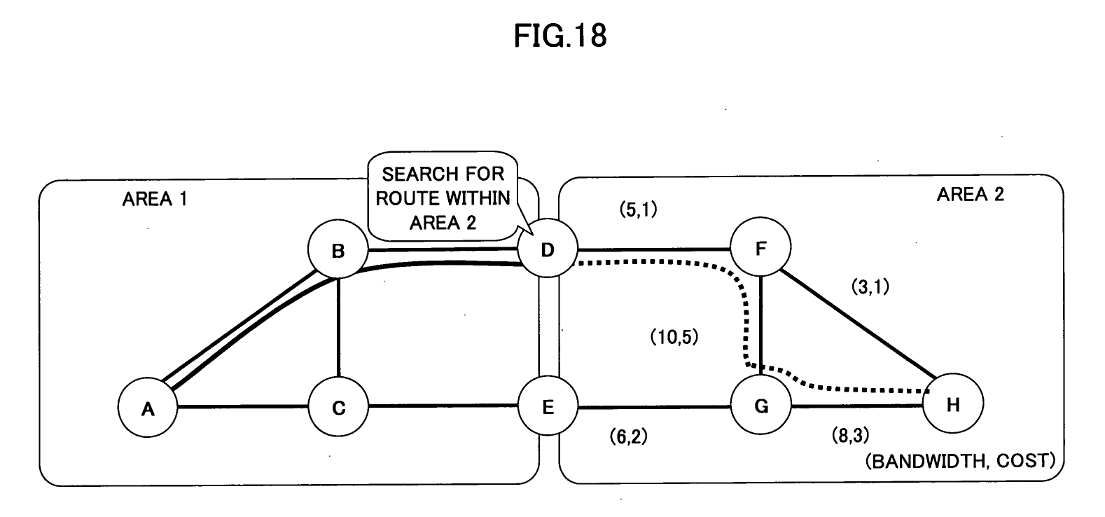

In the configuration shown in FIG. 16, the node A selects the node D as a passing boundary node by performing route calculation using the routing protocol of the IP network as shown in FIG. 17, first. Then, the node A sends a path request message for the node H including the node D. Then, the node D calculates a path route of node D→node F→node G→node H that is only one route to the node H that satisfies required bandwidth=5 as shown in FIG. 18.

The cost of the whole path calculated in this way is 1+2+1+5+3=12. But, the cost of a path of a route of node A→node C→node E→node G→node H is 10 that is smaller than the cost of the calculated route. That is, as a result, an optimum route is not selected where the optimum route is a route satisfying the required bandwidth and having the smallest cost.

The node A calculates a shortest route that strides over the area 1 and the area 2 using the routing protocol of the IP network so as to determine a passing boundary node based on the shortest route. But, since the routing protocol of the IP network uses only cost information so that route calculation considering bandwidth cannot be performed, and the above-mentioned problem occurs.

<Scheme for Solving the Above-Mentioned Problem>

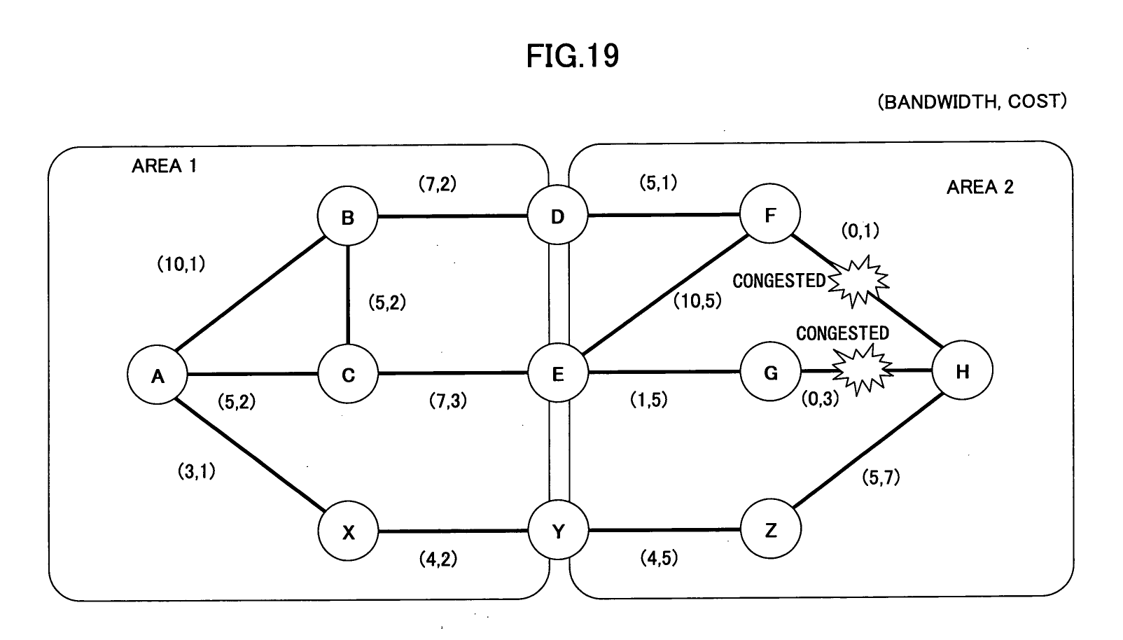

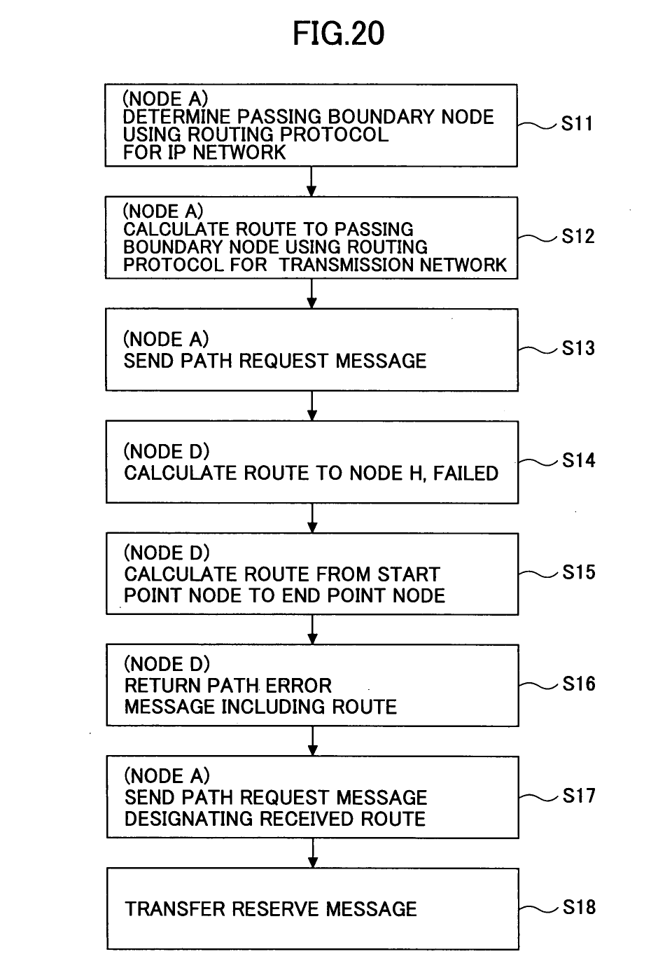

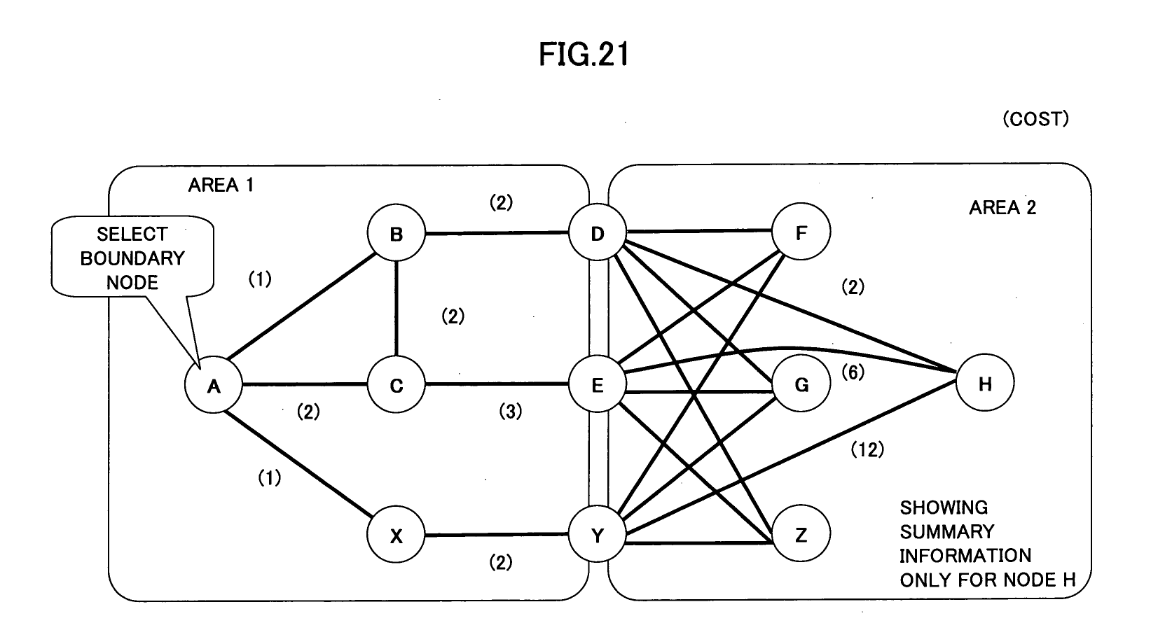

Next, a scheme for solving the above-mentioned problem is described. First, basic operation of this scheme is described. In this scheme, in a network status shown in FIG. 19, processes for establishing a path of required bandwidth=3 from the node A to the node H are described with reference to FIGS. 21-25 along the procedure shown in FIG. 20. As shown in FIG. 19, it is assumed that a link of node F→node H and a link of node G→node H are congested, so that available bandwidth for each of the links is 0.

As shown in FIG. 21, first, the node A determines a boundary node on a route having minimum cost among routes from the node A to the node H using the routing protocol of the IP network in step 11 in FIG. 20. In the example of FIG. 21, since the cost of the route of node A→node B→node D→ [symbol] H is the minimum, the node D is extracted as a passing boundary node.

Next, the node A calculates a route satisfying the required bandwidth=3 from the node A to the node D in the area 1 using the routing protocol of the transmission network in step 12 in FIG. 20. In this example, since a route of node A→node B→node D is the minimum cost route that satisfies the required bandwidth=3, the route of node A→node B→node D is calculated as the route for the path to be established.

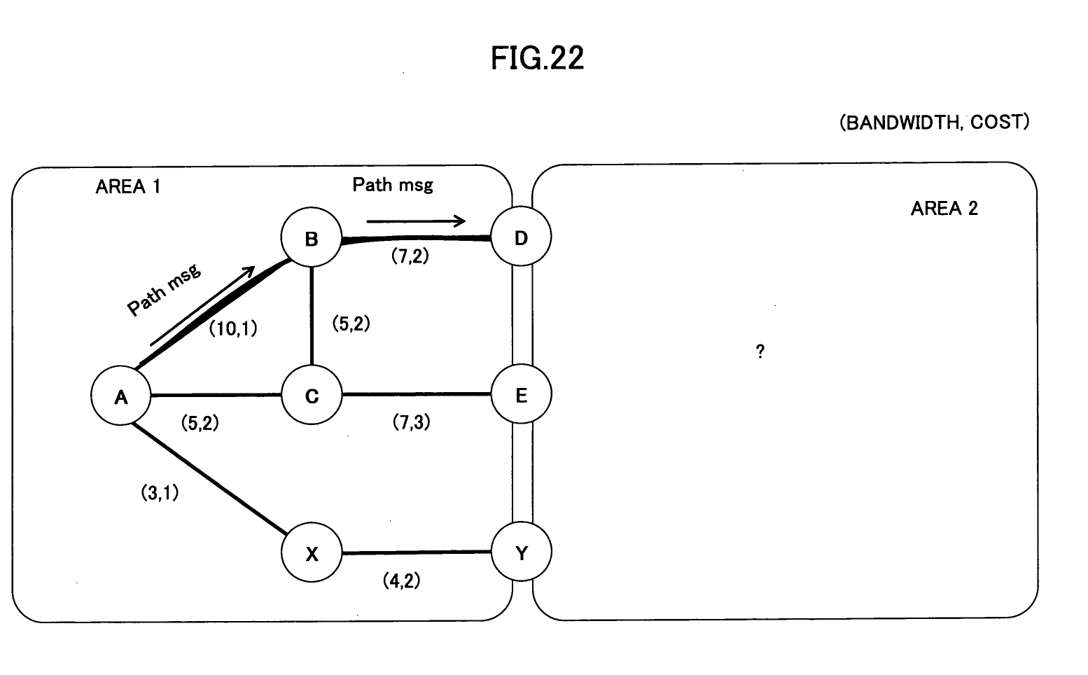

Then, as shown in FIG. 22, the node A sends a path request message designating the route of node A→node B→node D→node H and designating the required bandwidth to the node B based on the signaling protocol of the transmission network in step 13 in FIG. 20. The node B sends the path request message to the node D.

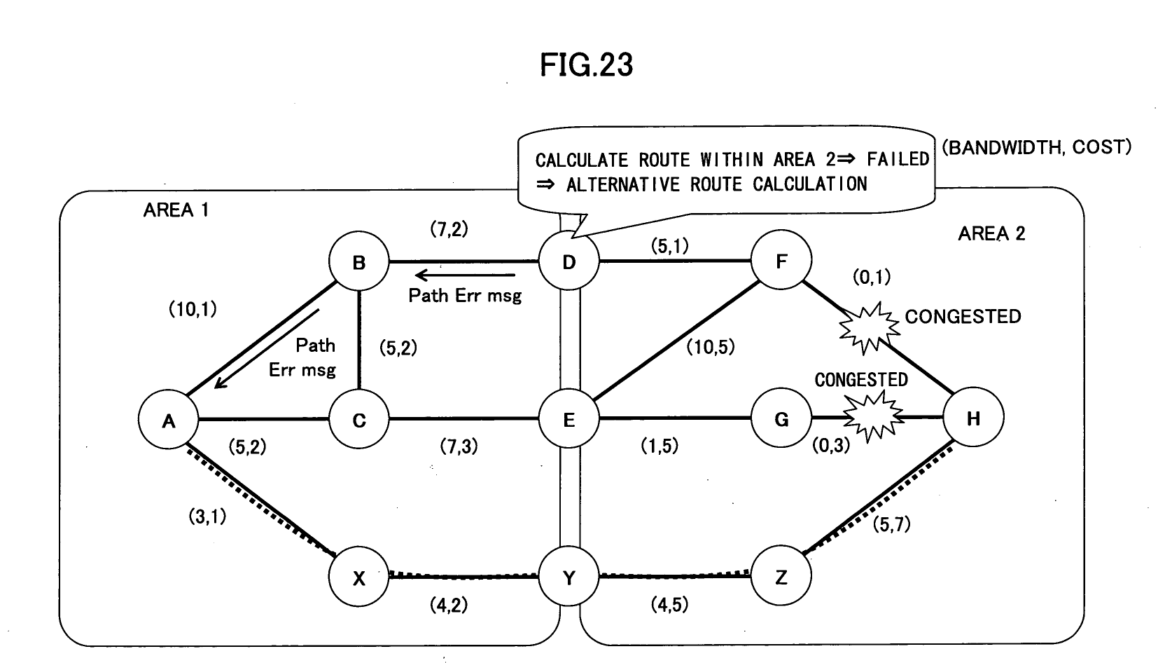

As shown in FIG. 23, the node D receives the path request message, and the node D tries to calculate a route to the node H in the area 2. But, since there is no route that is reachable from the node D to the node H and that satisfies the required bandwidth=3 in the area 2, the node D fails in the route calculation in step 14 in FIG. 20.

The node D that failed in the route calculation has topology information for both of the area 1 and the area 2 according to the routing protocol of the transmission network. Thus, the node D calculates a route from the node A to the node H satisfying the required bandwidth=3 using the topology information in step 15 in FIG. 20. By the way, information of the start point node and the end point node are included in the received path request message. In this example, a route of node A→node X→node Y→node Z→node H is calculated.

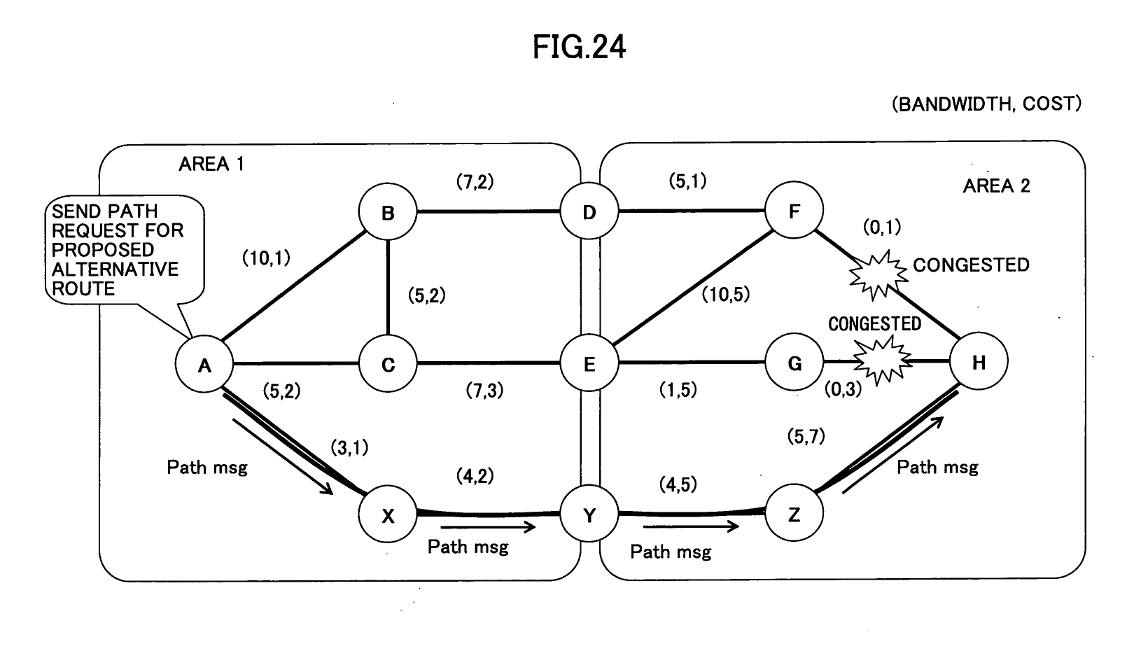

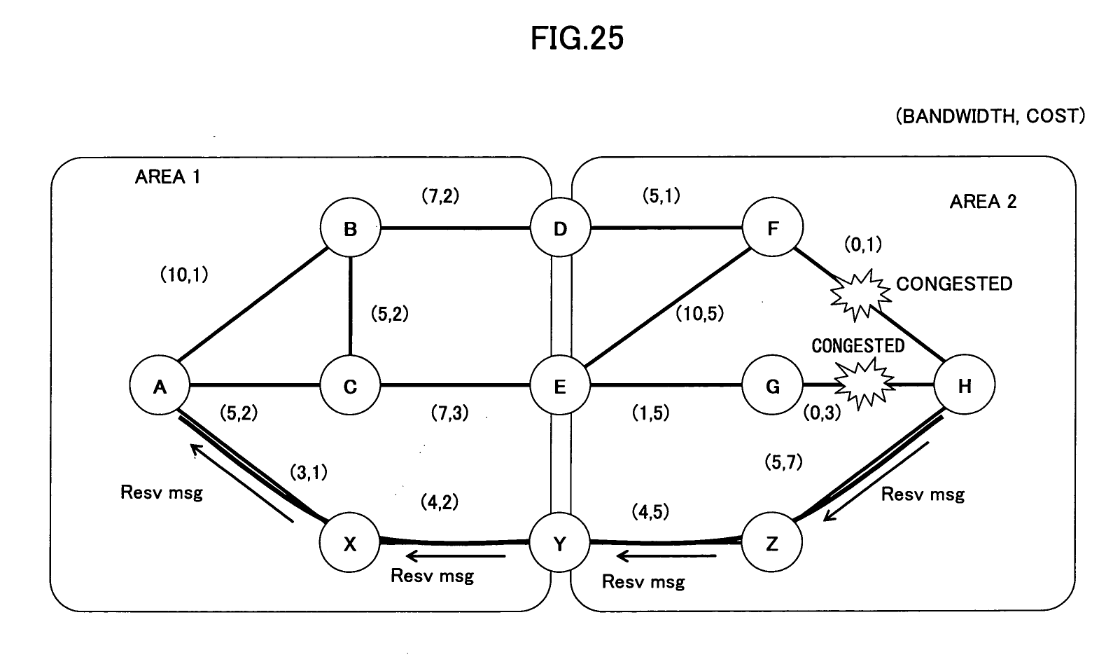

Then, the node D returns a path error message including the calculated route (node A→node X→node Y→node Z→node H) to the node A in step 16 in FIG. 20. The path error message is sent to the node A via the node B. The node A that receives the path error message sends a path request message designating the route (node A→node X→node Y→node Z→node H) included in the path error message to the node X in step 17 in FIG. 20. The path request message is sent to the node H via the route as shown in FIG. 24. After that, a reserve message is sent from the node H to the node Z in step 18 in FIG. 20. The reserve message is transferred in a reverse direction over the route so as to arrive the node A as shown in FIG. 25. Accordingly, a path, from the node A to the node A, striding over the area 1 and the area 2 can be established.

By the way, when there are a plurality of routes that are reachable from node A to the node H and that satisfy the required bandwidth, the node D may select a route having the minimum cost. In addition, the node D may send calculated all routes with each cost to the node A so that the node A performs path establishment process based on a route of the minimum cost.

### MODIFIED EXAMPLE 1

In the above example, the node D performs calculation of the route from the node A to the node H when the node D fails in calculation of a route to the node H in the area 2. In this modified example, calculation of the route from the node A to the node H may be performed first without performing route calculation in the area 2. In this case, when the node D does not exist on a calculated route, a path error message including a route calculation result is returned to the node A, and when a route passing through the node D is calculated, a path request message designating the calculates route in the area 2 is sent.

According to this modified example 1, since route calculation from the start point node to the end point node is performed irrespective of failure/success of the route calculation in the area 2 at the boundary node, an optimum route can be surely calculated so that a path of the optimum route can be established.

### MODIFIED EXAMPLE 2

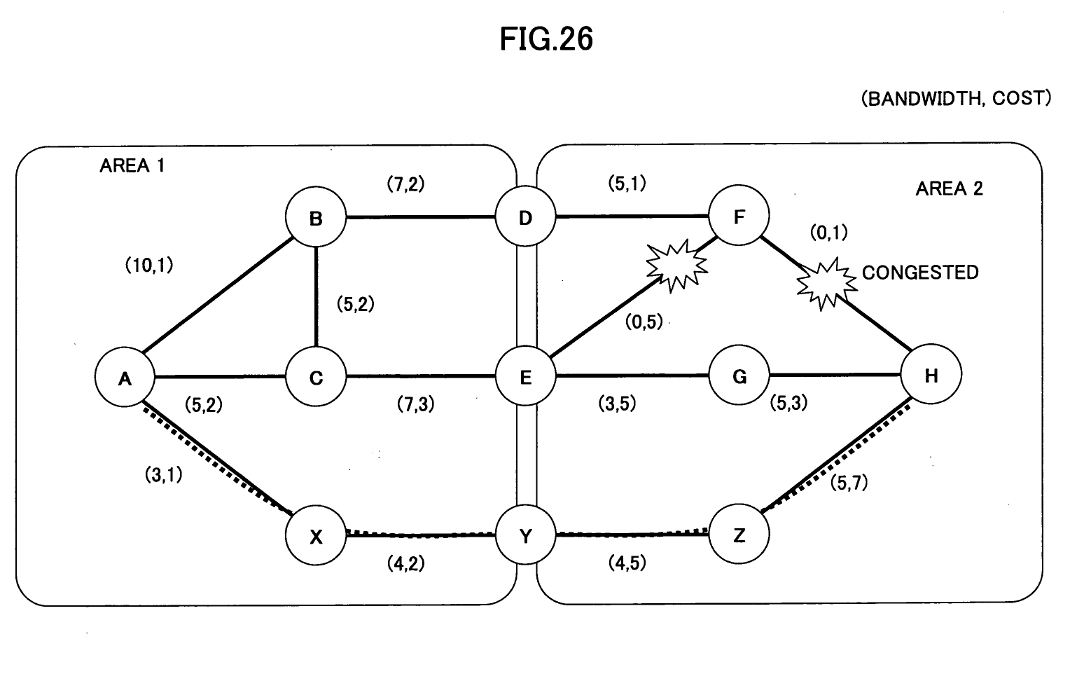

In the modified example 2, the node that fails in route calculation in the area 2 performs route calculation from the node A to the node H so as to obtain every boundary node through which a path can pass from the area 1 to the area 2 and send every boundary node to the node A using a path error message. For example, in an example of a network shown in FIG. 26, if required bandwidth is 3, nodes E and Y are extracted so that these nodes are sent to the node A by the path error message.

The node A that receives the path error message selects one of received passing boundary nodes to perform route calculation from the node A to the selected passing boundary node to obtain an optimum route satisfying the required bandwidth. When any route is not calculated, the node A calculates a route to another passing boundary route. When a route is calculated, the node A sends a path request message designating the route. The passing boundary node that receives the path request message performs route calculation in the area 2 and sends a path request message designating the calculated route so as to establish a path in the area 2.

Since a topology database in the node D does not necessarily completely reflect current status of the network, there may be a case where a calculated route actually passes through a congested link. Thus, by presenting a plurality of candidates to the node A, even when path calculation is failed for a boundary node, it becomes possible to immediately try path calculation using a next candidate.

In the above-mentioned example, the node D may describe boundary nodes in ascending order of cost from the boundary node to the node H in the path error message. For example, the node D may describe a boundary node by which the minimum cost is obtained first. Accordingly, the node A that receives the path error message can start path calculation from the boundary node described first so that the possibility that an optimum route can be determined increases.

The node D may send to the node A a path error message including only a boundary node, of passing boundary nodes, by which the optimum route to the end point node is obtained. The node A that receives the path error message calculates a route in the area 1 to the boundary node, and after the route is calculated, the node A sends a path request message designating the route. When the route is not calculated, the node A removes the node D and the boundary node so as to determine a passing boundary node using the routing protocol of the IP network and sends a path request message.

### MODIFIED EXAMPLE 3

In the modified example 3, in step 15 in FIG. 20, the node D calculates a route from the node A to the node H satisfying the required bandwidth using the topology information of the transmission network of the area 1 and the area 2, and sends, to the node A, a path error message including every boundary node through which a route can pass from the area 1 to the area 2 and including costs from each boundary node to the node H. The node A that receives the path error message determines a boundary node on an optimum route satisfying the required bandwidth using the topology information and received cost information.

For example, in a network configuration in a state shown in FIG. 26, for establishing a path of required bandwidth=3 from the node A to the node H, the node A receives from the node D a path error message including information node E/cost 8 and node Y/cost 12 as boundary node information. Then, the node A calculates an optimum route to the node E in the area 1. In addition, the node A calculates an optimum route to the node Y in the area 1. Then, the node A selects a boundary node on a route from the node A to the node H having a smaller cost using cost information included in the path error message so as to perform path establishment process.

By using the above-mentioned scheme, the above-mentioned problem in the basic operation can be solved so that establishment of a path striding over areas can be performed efficiently.

(Configuration Example of a Transmission Apparatus)

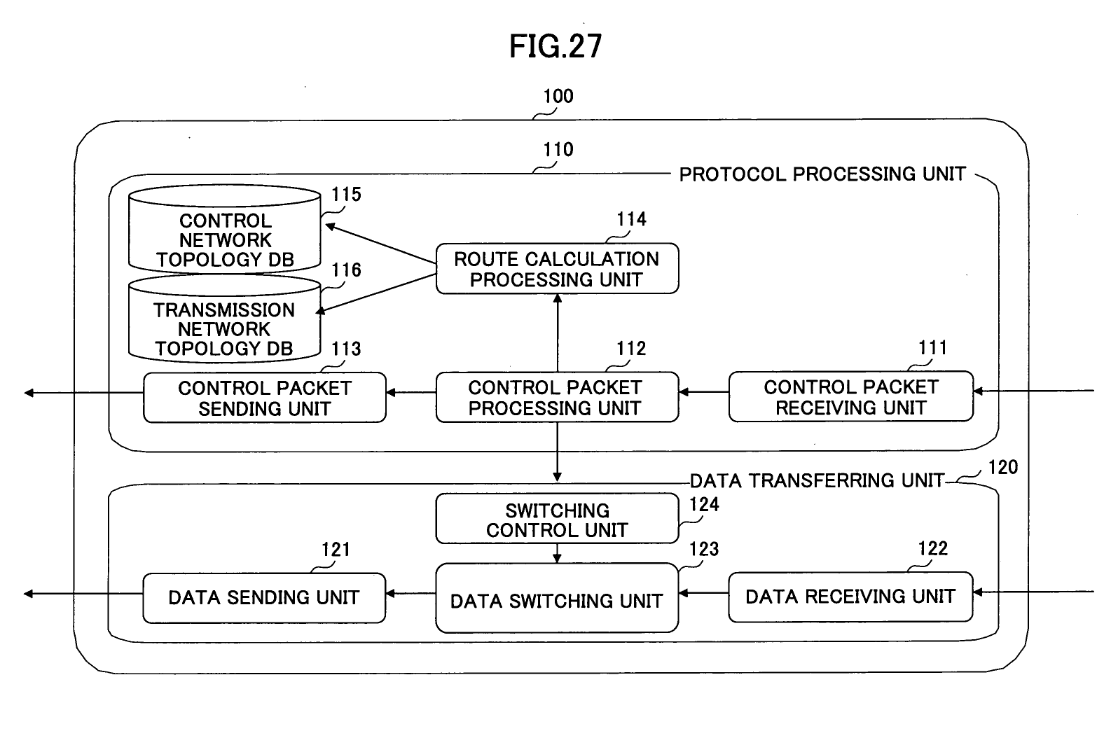

Next, a functional configuration example of a transmission apparatus 100 that forms each node in embodiments of the present invention is described with reference to FIG. 27.

As shown in FIG. 27, the transmission apparatus 100 of this embodiment includes a protocol processing unit 110 for performing the routing protocol and the signaling protocol on a control network (IP network), and a data transferring unit 120 for performing data transferring processes on the transmission network (label switch network).

The protocol processing unit 110 includes a control packet receiving unit 111, a control packet processing unit 112, a control packet sending unit 113, a route calculation processing unit 114 and a control network topology DB (database) 115 and a transmission network topology DB 116.

The control packet sending unit 111 is a functional unit for sending various messages of the above-mentioned protocols using IP packets. The control packet receiving unit 112 is a functional unit for receiving the various messages of the above-mentioned protocols as IP packets.

In performing the signaling protocol, the control packet processing unit 112 launches the route calculation processing unit 114 when a next route is unknown and when receiving a path error message, for example. In addition, the control packet processing unit 112 sends necessary setting information for data transfer to the data transferring unit 120 according to route information and required bandwidth (required quality) included in the message of the signaling protocol. That is, the control packet processing unit 112 sends path setting information. In addition, in performing the routing protocol of the control network or the transmission network, the control packet processing unit 112 collects link information (topology information) to store the link information in the control network topology DB 115 or in the transmission network topology DB 116.

As described in embodiments so far, the route calculation processing unit 114 calculates an exit boundary node using the control network topology DB 115 and calculates a route of path of the transmission network using the transmission network topology DB 116, for example.

The control network topology DB 115 stores at least link information for the control network of a belonging area or summary information in which link information of other areas are summarized. The link information includes at least identifiers of end points of a link and a cost of the link.

The transmission network topology DB 116 stores at least link information of the transmission network of the belonging area. The link information includes a plurality of attributes such as identifiers of end points of a link, a cost of the link, bandwidth and the like.

The data transferring unit 120 includes a data sending unit 121, a data receiving unit 122, a data switching unit 123, and a switching control unit 124. Send/receive and switching for user data in the transmission network are performed by the data sending unit 121, the data receiving unit 122 and the data switching unit 123. In addition, the switching control unit 124 controls the data switching unit 123 based on setting information determined by the control packet processing unit 112. By the way, the protocol processing unit 110 and the data transferring unit 120 can be implemented as the same apparatus or may be implemented as separated apparatuses.

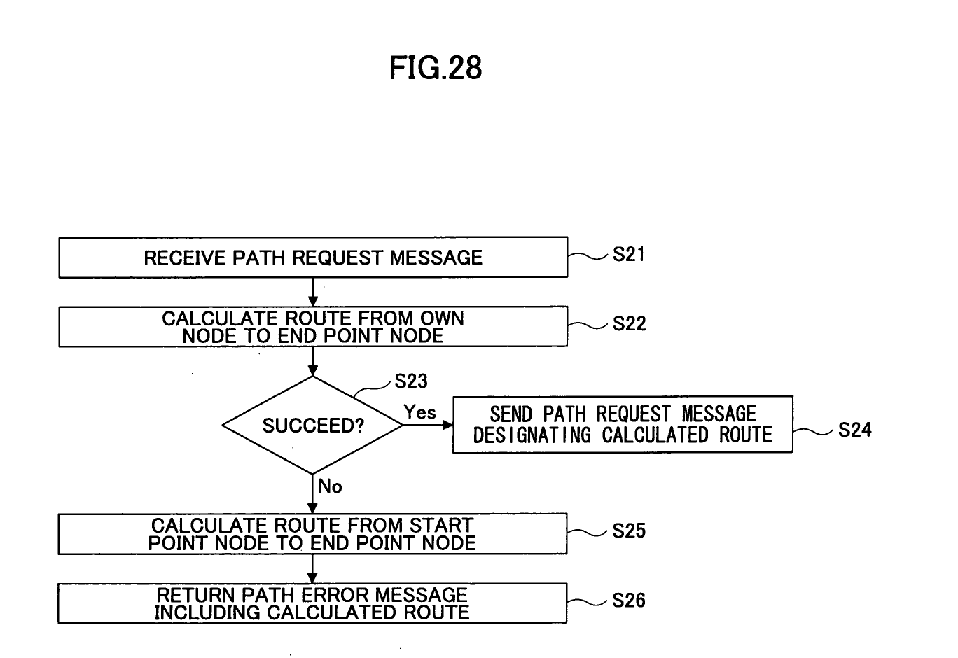

An example of basic process performed by the transmission apparatus 100 shown in FIG. 27 is described with reference to a flowchart of FIG. 28 assuming that the transmission apparatus 100 is the node D shown in FIG. 19, and that a path from the node A to the node H is established. This process is performed by the protocol processing unit 110 in the transmission apparatus 100.

First, the transmission apparatus 100 (node D) receives a path request message including information indicating that a start point node is the node A and an end point node is the node H in step 21. The transmission apparatus 100 performs calculation of a route to the node H that satisfies the required bandwidth using data in the transmission network topology DB 116 in step 22. When the calculation of the route succeeds (Yes in step 23), the transmission apparatus 100 sends a path request message designating the route in step 24.

When the calculation is failed (No in step 23), the transmission apparatus 100 performs calculation of an optimum route of a path from the node A to the node H using the data in the transmission network topology DB 116 in step 25, Then, the transmission apparatus 100 sends a path error message including a calculated route to the node A in step 26.

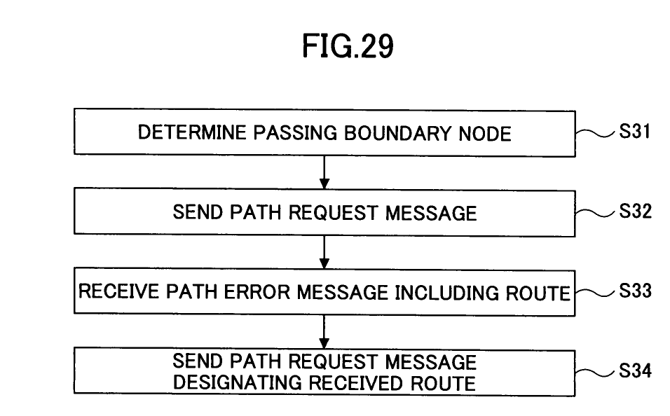

Next, an example of basic process performed by the transmission apparatus 100 is described with reference to a flowchart of FIG. 29 assuming that the transmission apparatus 100 is the node A shown in FIG. 19, and that a path from the node A to the node H is established.

First, the transmission apparatus 100 (node A) determines a boundary node using data in the control network topology DB 115 in step 31. Then, the transmission apparatus 100 sends a path request message including designation of the boundary node to an adjacent node in step 32. Then, when the transmission apparatus 100 receives a path error message, sent from the boundary node, including a route from the node A to the node H in step 33, the transmission apparatus 100 sends a path request message designating the route without performing route calculation in step 34.

The present invention is not limited to the specifically disclosed embodiments, and variations and modifications may be made without departing from the scope of the present invention.

The present application contains subject matter related to Japanese patent application No.2006-263122, filed in the JPO on Sep. 27, 2006, the entire contents of which are incorporated herein by reference.

What is claimed is:

1. A transmission apparatus for establishing a path between a start point node and an end point node, wherein the transmission apparatus is used as a boundary node between a first area and a second area in a network which is divided into at least the first area and the second area, and the start point node resides in the first area and the end point node resides in the second area, the transmission apparatus comprising:
a calculation unit configured to calculate information related to a route between the start point node and the end point node using topology information of the first area and topology information of the second area when receiving a path request message from the first area based on a signaling protocol for path establishment; and
a sending unit configured to send a message including the calculated information on the route to the start point node.

2. The transmission apparatus as claimed in claim 1, the transmission apparatus further comprising a route calculation unit configured to calculate a route from the transmission apparatus to the end point node using the topology information of the second area when receiving the path request message from the first area,
wherein, when route calculation by the route calculation unit is failed, the transmission apparatus calculates the information related to the route between the start point node and the end point node, and sends the message including the information related to the route to the start point node.

3. The transmission apparatus as claimed in claim 2, wherein, when the transmission apparatus succeeds in the route calculation by the route calculation unit, the transmission apparatus sends a path request message designating the route to the second area based on the signaling protocol.

4. The transmission apparatus as claimed in claim 1, wherein the information related to the route calculated by the calculation unit is information of the route between the start point node and the end point node.

5. The transmission apparatus as claimed in claim 1, wherein the information related to the route calculated by the calculation unit is information of boundary nodes each being on a route of a path that can be established between the start point node and the end point node.

6. The transmission apparatus as claimed in claim 1, wherein the information related to the route calculated by the calculation unit is information of a boundary node though which a route having a minimum cost passes among boundary nodes each being on a route of a path that can be established between the start point node and the end point node.

7. The transmission apparatus as claimed in claim 1, wherein the information related to the route calculated by the calculation unit includes boundary nodes each being on a route of a path that can be established between the start point node and the end point node, and cost information between each of the boundary nodes and the end point node.

8. A transmission apparatus used as a start point node on a path between the start point node and an end point node in a network which is divided into at least a first area and a second area, wherein the start point node resides in the first area and the end point node resides in the second area, the transmission apparatus comprising:
a determination unit configured to determine a boundary node, between the two areas, on a route having a minimum cost between the start point node and the end point node using a routing protocol that can advertise topology summary information between areas;
a sending unit configured to send a path request message including designation of the boundary node to an adjacent node based on a signaling protocol for path establishment;
a receiving unit configured to receive a message, from the adjacent node, that includes information related to a route of the path calculated by the boundary node and that is sent by the boundary node; and
a path establishment processing unit configured to perform processes for establishing the path using the information related to the route included in the message.

9. The transmission apparatus as claimed in claim 8, wherein, when the information related to the route included in the message is information of a route between the start point node and the end point node, the path establishment processing unit sends a path request message designating the route to the adjacent node.

10. The transmission apparatus as claimed in claim 8, wherein, when the information related to the route included in the message is information of boundary nodes each being on a route of a path that can be established between the start point node and the end point node, the path establishment processing unit calculates a route to a boundary node out of the boundary nodes using topology information of the first area, and sends a path request message including designation of the route to an adjacent node.

11. The transmission apparatus as claimed in claim 8, wherein, when the information related to the route included in the message is information of a boundary node through which a route to the end point node having a minimum cost passes among boundary nodes each being on a route of a path that can be established between the start point node and the end point node, the path establishment processing unit calculates a route to the boundary node using topology information of the first area, and sends a path request message including designation of the route to an adjacent node.

12. The transmission apparatus as claimed in claim 8, wherein, when the information related to the route included in the message includes boundary nodes each being on a route of a path that can be established between the start point node and the end point node, and cost information between each of the boundary nodes and the end point node, the path establishment processing unit determines a boundary node on a route having a minimum cost between the start point node and the end point node using the received information and topology information of the first area, and sends a path request message including designation of the boundary node to an adjacent node.

13. A path establishing method for establishing a path between a start point node and an end point node in a network which is divided into at least a first area and a second area, wherein the start point node resides in the first area and the end point node resides in the second area, wherein:
the start point node determines a boundary node, between the two areas, on a route having a minimum cost between the start point node and the end point node using a routing protocol that can advertise topology summary information between areas;
the start point node sends a path request message including designation of the boundary node to an adjacent node based on a signaling protocol for path establishment;
the boundary node receives the path request message, and calculate information related to a route between the start point node and the end point node using topology information of the first area and topology information of the second area;
the boundary node sends a message including the calculated information related to the route to the start point node based on the signaling protocol;
the start point node receives the message, sent by the boundary node, that includes the information related the route; and
the start point node performs processes for establishing the path using the information related to the route included in the message.
